(19) United States
(12) Patent Application Publication
(10) Pub. No.: US 2006/0101483 A1
(43) Pub. Date: May 11, 2006

(54) Clutching device for a gearbox

(76) Inventor: Chen-Chia Chen, Kaohsiung (TW)

Correspondence Address: CHARLES E. BAXLEY, ESQ., 90 JOHN STREET, THIRD FLOOR, NEW YORK, NY, 10038, US

(21) Appl. No.: 10/984,476

(22) Filed: Nov. 8, 2004

(51) Int. Cl. G11B 17/03; G11B 19/20; G11B 17/028

(52) U.S. Cl. 720/715

(57) ABSTRACT

A clutching device has a spindle, a gear, a sliding rod and a pin. The spindle has an opening defined in one end of the spindle and a pin channel defined in the outer surface and communicating with the opening. The gear is mounted on the spindle and has an annular flange formed on a side facing the pin channel and multiple engaging notches radially defined in the flange and corresponding to the pin channel. The sliding rod is slidably inserted into the opening with a first end of the sliding rod and has a second end exposed from the opening. The pin is attached to the first end of the sliding rod, extends through the pin channel in the spindle and selectively engages with one of the engaging notches in the flange on the gear. Accordingly, a simplified clutching device is provided to conveniently disengage a spindle from a gear.

### BACKGROUND OF THE INVENTION

1. Field of the Invention

The present invention relates to a clutching device, and more particularly to a clutching device for a gearbox.

2. Description of Related Art

A gearbox is arranged between a driving device, such as a motor and a transmission device to reduce the output speed generated by the driving device and transmitted to the transmission device. A conventional gearbox substantially comprises a casing, an input spindle, an output spindle and a gear assembly. The input spindle is rotatably mounted on the casing and is connected to a driving device. The output spindle is rotatably mounted on the casing and is connected to a transmission device. The gear assembly is mounted between the input spindle and the output spindle and comprises multiple gears meshable with the others. With the arrangement of the gear assembly, the rotating speed generated by the driving device and applied to the transmission the device will be reduced.

However, when electrical power failure occurs, a gate arrangement in the gearbox cannot be opened or closed manually due to the engagements of the gears of the gear assembly or a brake effect provided by the driving device. To rotate the output spindle manually, a clutching device is mounted in the gearbox to disengage the output spindle from the gear assembly. However, the conventional clutching device has a complex structure, and to arrange a conventional clutching device into a gearbox is costly and difficult.

To overcome the shortcomings, the present invention tends to provide a clutching device to mitigate or obviate the aforementioned problems.

### SUMMARY OF THE INVENTION

The main objective of the invention is to provide a clutching device that has a simplified structure and is convenient to disengage a spindle from a gear. The clutching device has a spindle, a gear, a sliding rod and a pin. The spindle has an opening defined in one end of the spindle and a pin channel defined in the outer surface and communicating with the opening. The gear is mounted on the spindle and has an annular flange formed on a side facing the pin channel and multiple engaging notches radially defined in the flange and corresponding to the pin channel. The sliding rod is slidably inserted into the opening with a first end of the sliding rod and has a second end exposed from the opening. The pin is attached to the first end of the sliding rod, extends through the pin channel in the spindle and selectively engages with one of the engaging notches in the flange on the gear.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a clutching device in accordance with the present invention;

FIG. 2 is an exploded perspective view of the clutching device in FIG. 1;

FIG. 3 is a side plan view in partial cross section of a gear box with the clutching device in FIG. 1; and

FIG. 4 is an exploded perspective view of the clutching device in FIG. 1 showing that the spindle disengages from the gear.

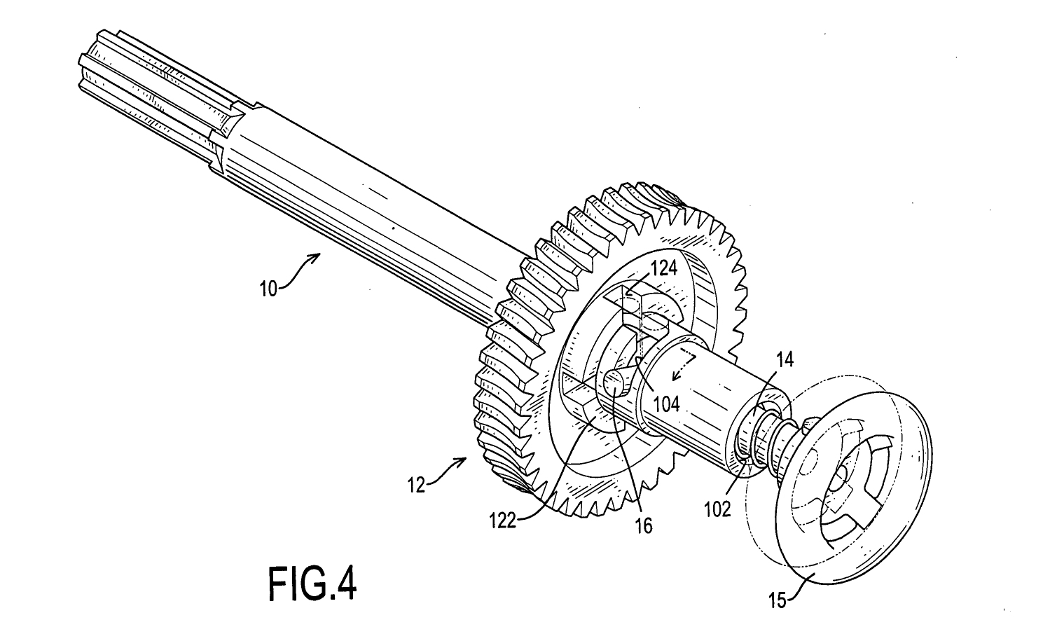

### DETAILED DESCRIPTION OF PREFERRED EMBODIMENT

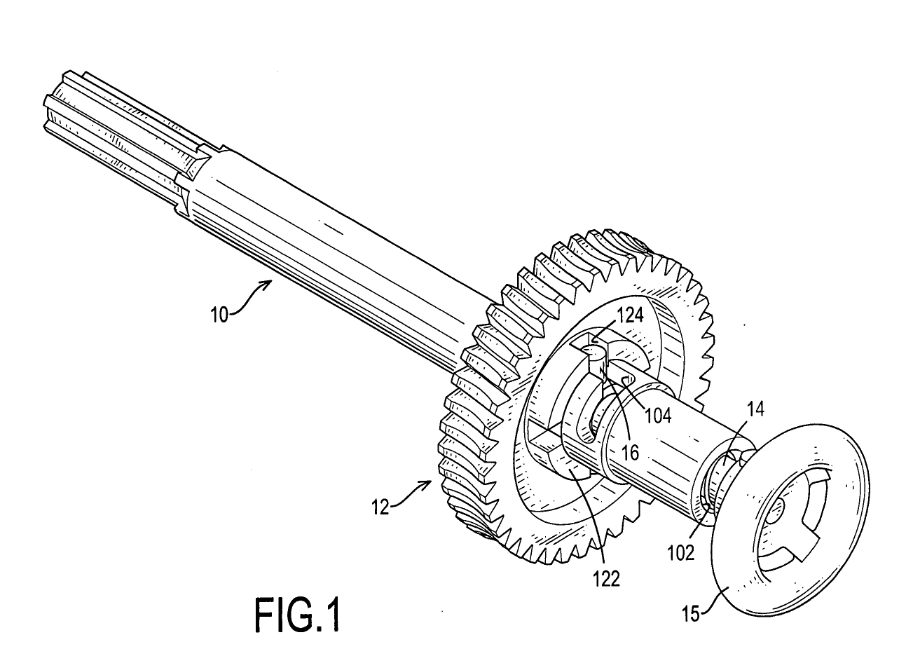

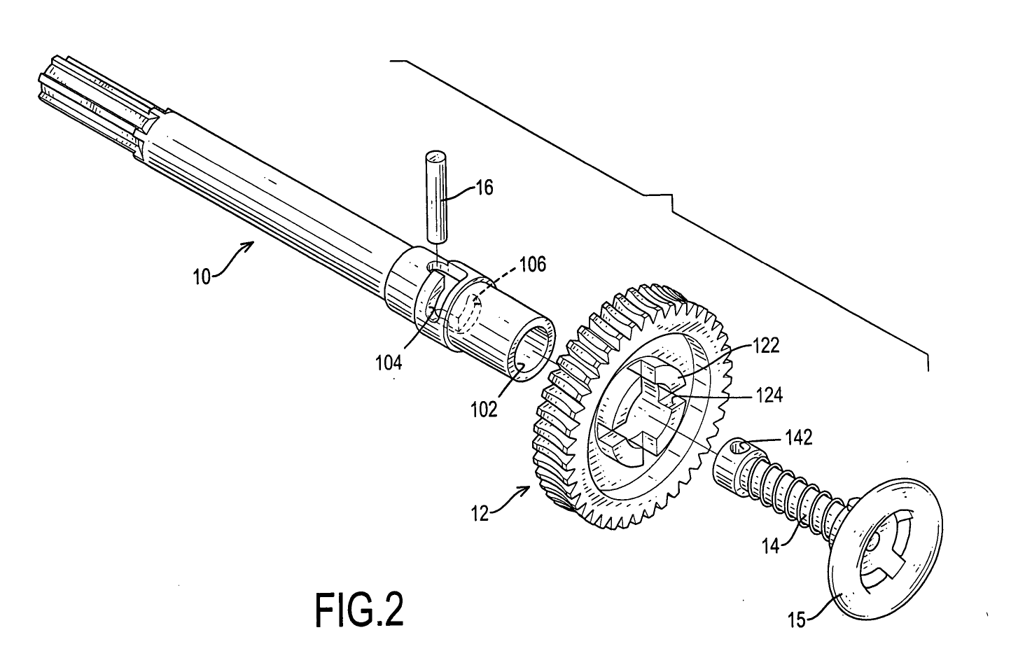

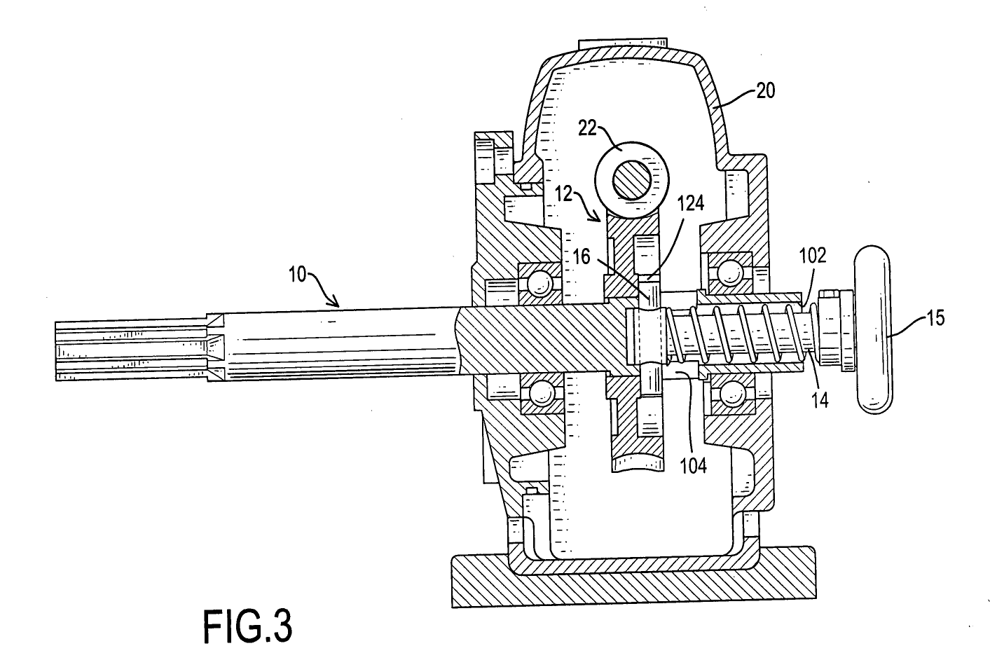

With reference to FIGS. 1 to 3, a clutching device in accordance with the present invention comprises a spindle (10), a gear (12), a sliding rod (14) and a pin (16). The spindle (10) is rotatably mounted on a casing (20) of a gearbox and is adapted to connect to a transmission device. The transmission device can be use to open or close a gate. The spindle (10) has an outer surface, an opening (102) and a pin channel (104). The opening (102) is defined in on end of the spindle (10), and the pin channel (104) is defined in the outer surface and communicates with the opening (102). In an embodiment, the pin channel (104) can be a straight channel longitudinally defined in the outer surface of the spindle (10). In a preferred embodiment, the pin channel (104) is L-shaped as shown. In an alternative embodiment, an auxiliary pin channel (106) is defined in the outer surface, communicates with the opening (102) and can be L-shaped, as shown in FIG. 3. The pin channel (104) and the auxiliary pin channel (106) are located respectively at opposite ends of a diameter of the spindle (10).

The gear (12) is mounted on the spindle (10) and has an annular flange (122) and multiple engaging notches (124). The flange (122) is formed on the gear (12) at a side facing the pin channel (104). The engaging notches (124) are radially defined in the flange (122) and correspond to the pin channel (104). The gear (12) engages with a gear (22) of a gear assembly in the gearbox.

The sliding rod (14) is slidably inserted into the opening (102) with a first end of the sliding rod (14) and has a second end exposed from the opening (102). With an L-shaped pin channel (104), the sliding rod (14) is also rotatably inserted into the opening (102) to allow the sliding rod (14) to rotate relative to the spindle (10). In an operational embodiment, a handle (15) is attached to the second end of the sliding rod (14) to enable a user to pull, push or rotate the sliding rod (14) conveniently.

The pin (16) is attached to the first end of the sliding rod (14), extends through the pin channel (104) in the spindle (10) and selectively engages with one of the engaging notches (124) in the flange (122) on the gear (12). With the arrangement of the auxiliary pin channel (106), two ends of the pin (16) extend respectively through the pin channel (104) and the auxiliary pin channel (106) and respectively into an aligned pair of the engaging notches (124) in the gear (12). In addition, the first end of the sliding rod (14) has a bore (142) radially defined through the first end. The pin (16) is pressed into the bore (142) in the first end of the sliding rod (14) so as to securely attach to the first end of the sliding rod (14).

When a driving device is powered on, the gear (12) will be rotated with the transmission of the gear assembly in the gearbox. With the engagement of the pin (16) and the corresponding engaging notches (124) in the flange (122) on the gear (12), the spindle (10) will rotate with the gear (12), such that the power will be output through the spindle (10) at a reduced speed.

When power failure occurs and the user wants to open or close the gate, the sliding rod (14) is pulled outward from the opening (102) in the spindle (10). The pin (16) will slide along the pin channel (104) and the auxiliary pin channel (106) and will disengage from the notches (124) in the gear (12). With the L-shape of the pin channel (104) and the auxiliary pin channel (106), the pin (16) can enter another segment of the pin channels (104,106) by rotating the sliding rod (14). The spindle (10) is disengaged from the gear (12), so the user can rotate the spindle (10) with a low load. Accordingly, the user can open or close the gate manually when electrical power is interrupted.

When the user pulls the sliding rod (14) into the opening (102), the pin will reengage with the engaging notches (124) in the gear and the spindle (10) and the gear (12) also reengage.

In such an arrangement, a simplified clutching device is provided, and to arrange a clutching device into a gearbox is easy and economic.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clutching device comprising:
a spindle with an outer surface having
an opening defined in one end of the spindle; and
a pin channel defined in the outer surface and communicating with the opening;
a gear mounted on the spindle and having a side facing the pin channel, an annular flange formed on the side and multiple engaging notches radially defined in the flange and corresponding to the pin channel;
a sliding rod slidably inserted into the opening with a first end of the sliding rod and having a second end exposed from the opening; and
a pin attached to the first end of the sliding rod, extending through the pin channel in the spindle and selectively engaging with one of the engaging notches in the flange on the gear.

2. The clutching device as claimed in claim 1 further comprising a handle attached to the second end of the sliding rod.

3. The clutching device as claimed in claim 2, wherein the first end of the sliding rod has a bore radially defined through the first end; and
the pin is pressed into the bore in the first end of the sliding rod.

4. The clutching device as claimed in claim 3, wherein the pin channel is L-shaped.

5. The clutching device as claimed in claim 4 further comprising an L-shaped auxiliary pin channel defined in the outer surface of the spindle and communicating with the opening,
wherein the pin channel and the auxiliary pin channel are located respectively at opposite sides of a diameter of the spindle, and
the pin has two ends extending respectively through the pin channel and the auxiliary pin channel and respectively into two of the engaging notches.

6. The clutching device as claimed in claim 1, wherein the first end of the sliding rod has a bore radially defined through the first end; and
the pin is pressed into the bore in the first end of the sliding rod.

7. The clutching device as claimed in claim 6, wherein the pin channel is L-shaped.

8. The clutching device as claimed in claim 7 further comprising an L-shaped auxiliary pin channel defined in the outer surface of the spindle and communicating with the opening,
wherein the pin channel and the auxiliary pin channel are located respectively at opposite sides of a diameter of the spindle, and
the pin has two ends extending respectively through the pin channel and the auxiliary pin channel and respectively into two of the engaging notches.

9. The clutching device as claimed in claim 1, wherein the pin channel is L-shaped.

10. The clutching device as claimed in claim 9 further comprising an L-shaped auxiliary pin channel defined in the outer surface of the spindle and communicating with the opening,
wherein the pin channel and the auxiliary pin channel are located respectively at opposite sides of a diameter of the spindle, and
the pin has two ends extending respectively through the pin channel and the auxiliary pin channel and respectively into two of the engaging notches.

11. The clutching device as claimed in claim 1 further comprising an auxiliary pin channel defined in the outer surface of the spindle and communicating with the opening,
wherein the pin channel and the auxiliary pin channel are located respectively at opposite sides of a diameter of the spindle, and
the pin has two ends extending respectively through the pin channel and the auxiliary pin channel and respectively into two of the engaging notches.
